(19) United States
(12) Patent Application Publication
(10) Pub. No.: US 2025/0258331 A1
(43) Pub. Date: Aug. 14, 2025

(54) HIGHLY FLEXIBLE AND DISTRIBUTED STRAIN-SENSING OPTICAL FIBER AND SYSTEM USING THE SAME

(71) Applicant: New Mexico Tech University Research Park Corporation, Socorro, NM (US)

(72) Inventor: Donghyeon Ryu, Socorro, NM (US)

(21) Appl. No.: 19/052,883

(22) Filed: Feb. 13, 2025

Related U.S. Application Data
(60) Provisional application No. 63/552,866, filed on Feb. 13, 2024.

(51) Int. Cl. G02B 6/02; B82Y 20/00; G01B 11/16

(52) U.S. Cl. CPC G02B 6/02033; B82Y 20/00; G01B 11/16; G02B 6/0229

(57) ABSTRACT

An optical fiber is provided with high mechanical flexibility and truly distributed strain sensing capability along the fiber direction for sensing in-plane mechanical strains on a human body surface or other non-planar biological structure. The optical fiber comprises a self-sensing material configured to emit a spectrum of colored lights upon sensing mechanical strain, without using an independent light source. In embodiments, the optical fiber comprises a polydimethylsiloxane fiber medium and a linear array of copper-doped zinc sulfide (ZnS:Cu) polydimethylsiloxane microdots integrated into a center of the fiber medium, each microdot configured to emit a unique irradiance spectrum due to variations in the composition of the ZnS:Cu particles and/or addition of different colored quantum dots. The ends of the optical fiber are coupled to optical detectors for capturing the multi-colored light emission spectrum and providing corresponding strain sensor data to a processor to generate an in-plane strain mapping along the fiber.

### TECHNICAL FIELD

This disclosure generally relates to optical fiber and more specifically, to a highly flexible and truly distributed strain-sensing optical fiber that can be used to monitor strains on a non-planar surface.

### BACKGROUND

Strain, or mechanical strain, is defined as a relative change in the length of an object under stress conditions (e.g., force or thermal). The resulting change can be an extension (such as, elongation or tension) or contraction (such as, decrease or compression) of the object. Strain sensors may be used to measure in-plane mechanical strains on the object by determining a ratio of the absolute change in length to the total length of the object. The strain measurements may be used to determine the tendency of an object to undergo failure depending on the amount of stress applied (e.g., due to wear and tear).

In general, in-plane strain measurements on a non-planar surface, such as the human body, can be challenging, primarily due to the unavailability of strain sensors that are compatible with biomaterial (e.g., human skin or body tissues) and capable of measuring strains in a continuous manner along a sensor network. For example, existing strain sensor technology, such as, e.g., metal foil strain gage and fiber Bragg grating (“FBG”), are made to sense strains on engineered materials and thus, are made of brittle or hard materials that lack the mechanical flexibility and/or stretchability needed to sense strain on a human body surface or other biological system. Moreover, while FBG, for example, is a distributed sensor technology, it requires the use of bulky and expensive equipment for providing a light source and taking strain measurements, which is not practical for body surface measurements.

Existing technology for tracking and monitoring human motion and physical phenomena on the human body are also incapable of mapping strains on the body surface. For example, while accelerometer-based monitoring systems (e.g., smart watches and other wearables) can be used to track human body motion, they place a low number and density of sensor nodes on the body, thus yielding insufficient sensor information for mapping multi-dimensional strains on the body surface. Other limitations of accelerometer-based systems include a high computational cost to process the accelerations, and a lack of information resulting from contact on the human body, e.g., for tracking muscle size and shape changes.

Accordingly, there is still a need in the art for a strain sensing and measuring system that has sufficient mechanical flexibility, strain sensing range, and even distribution to be used for in-plane strain sensing on a human body surface or other biological systems.

### SUMMARY

The invention is intended to solve the above-noted and other problems through systems, methods, and apparatus configured to provide: (1) an optical fiber made of a self-sensing material that is independent of a light source and has high mechanical flexibility and evenly distributed strain sensing capability that can be used for in-plane monitoring of a human body surface or other non-planar surface; (2) a low-cost strain-sensing device, comprising a dense network of the highly flexible and evenly distributed optical fiber, that can be used as a health monitoring wearable for mapping large scale, two-dimensional strains along the human body surface; and (3) a strain-sensing system configured to use the optical fiber network to build an adaptive physical digital twin model of the body surface as well as the entire body's physical movement and behaviors for diagnosis and prognosis of physiological and psychological health disorders, for example, by allowing the model to self-learn and self-evolve using a neural network.

One exemplary embodiment provides an optical fiber, comprising: a core configured to be deformable in a longitudinal direction of the fiber, the core comprising an elastomeric material; a plurality of sensor nodes disposed at a center of the core and arranged in close proximity to form a linear array along a length of the core, each sensor node comprising a mechano-luminescent (“ML”) composite configured to emit a select color of light in response to detecting a mechanical force at a location of the sensor node; and a coating configured to surround the core and confine light emissions to within the core.

According to various aspects, the elastomeric material comprises polydimethylsiloxane (“PDMS”).

According to some aspects, the ML composite comprises zinc sulfide (“ZnS”). According to other aspects, the ML composite comprises copper-doped zinc sulfide (“ZnS:Cu”). According to still other aspects, the ML composite comprises zinc sulfide (“ZnS”) doped with copper and manganese (“ZnS:Cu, Mn”).

According to various aspects, the ML composite comprises a microdot of copper-doped zinc sulfide (“ZnS:Cu”) and one or more quantum dots, each quantum dot comprising a zinc sulfide (“ZnS”) core doped with one or more metal ions.

According to some aspects, the coating is configured to cause total internal reflection of light emissions from the sensor nodes by having a first refractive index that is lower than a second refractive index of the core.

According to various aspects, the core is configured to extend through the optical fiber longitudinally and have a substantially circular cross-section, and the linear array of sensor nodes is disposed at a centroid of the circular cross-section.

According to some aspects, the plurality of sensor nodes are configured to: emit a first color spectrum in response to sensing a first mechanical strain, and emit a second color spectrum, different from the first spectrum, in response to sensing a second mechanical strain different from the first strain.

Another exemplary embodiment provides a strain-sensing system, comprising: an optical fiber configured to sense a mechanical force on the fiber and in response, emit a spectrum of colored lights, wherein the optical fiber comprises a linear array of sensor nodes disposed along a central core of the optical fiber, and each sensor node is configured to emit a select one of the colored lights upon sensing the mechanical force at a location of the sensor node; at least one optical detector coupled to the optical fiber and configured to: detect the spectrum of colored lights emitted by the sensor nodes, and generate an output signal based on the detected spectrum, the output signal representing strain information for corresponding node locations along the optical fiber; and at least one processor communicatively coupled to the at least one optical detector and a database, the at least one processor configured to: receive the output signal from the at least one optical detector; derive the strain information from the output signal; store the strain information in the database in association with the corresponding node locations; and generate, based on information obtained from the database, a strain map for the optical fiber.

According to various aspects, the central core comprises an elastomeric material that is deformable in a longitudinal direction of the fiber. According to some aspects, the elastomeric material comprises polydimethylsiloxane (“PDMS”).

According to various aspects, each sensor node comprises a mechano-luminescent (“ML”) composite configured to emit the select colored light upon sensing the mechanical force. According to some aspects, the ML composite comprises zinc sulfide (“ZnS”).

According to some aspects, the at least one optical detector comprises a photomultiplier tube.

According to various aspects, the at least one optical detector comprises a first optical detector coupled to a first end of the optical fiber, and a second optical detector coupled to a second end of the optical fiber.

According to some aspects, the at least one processor is further configured to: receive location information for each sensor node, and store the location information in the database in association with the strain information obtained for the corresponding sensor node.

According to some aspects, the spectrum of colored lights comprises visible and/or near visible wavelengths of light.

As will be appreciated, this disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

### BRIEF DESCRIPTION OF THE DRAWINGS

For a better understanding of the invention, reference may be made to embodiments shown in the drawings identified below. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a functional block diagram illustrating an exemplary strain-sensing system comprising an exemplary self-sensing optical fiber, in accordance with embodiments.

FIG. 2 is a schematic diagram illustrating a close-up view of multi-colored mechano-luminescent (“ML”) composites embedded within the self-sensing optical fiber of FIG. 1, in accordance with embodiments.

FIG. 3 is a graph illustrating light intensity of ML composites over a cycle of tensile loading and unloading, in accordance with embodiments.

FIG. 4 is a graph illustrating variations in light color for ML composites in response to changing strain rate and varying loading frequency, in accordance with embodiments.

FIG. 5 is a graph illustrating light intensity predictions based on strain, strain rate, and strain history inputs to a neural network trained with experimental data obtained after image processing of video recordings of prior ML light emissions, in accordance with embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

In the following description, elements, circuits and functions may be shown in block diagram form in order to not obscure the present disclosure in unnecessary detail. Additionally, block definitions and partitioning of logic between various blocks is exemplary of a specific embodiment. Further, those of ordinary skill in the art will understand that information and signals as depicted in the block diagrams may be represented using any variety of different technologies or techniques. For example, data, instructions, signals or commends may be represented in the figures, and which also would be understood as representing voltages, currents, electromagnetic waves or magnetic or optical fields, or combinations thereof. Additionally, some drawings may represent signals as a single signal for clarity of the description; and persons skilled in the art would recognize that the signal may represent a bus of signals. Various illustrative logic blocks, modules and circuits described in connection with embodiments disclosed herein may be implemented or performed with one or more processors. As would be appreciated and understood by persons of ordinary skill in the art, disclosure of separate processors in block diagrams may indicate a plurality of processors performing the functions or logic sequence disclosed herein, or may represent multiple functions or sequence performed on a single processor.

As used herein, the term “mechano-luminescence” (or “ML”) refers to a material's ability to generate light when a mechanical force (e.g., a mechanical strain or vibration) is applied to the material. Typically, materials exhibiting mechano-luminescence are inorganic crystals doped with micro-sized particles (or “dopants”).

As will be appreciated, the term “irradiance spectrum,” which refers to the distribution of energy across wavelengths, may be used to measure and characterize a light source. In other cases, the light emitted by a light source may be defined in terms of “peak wavelength,” which refers to the wavelength at which the light source emits the most energy.

In general, the motion and behavior of the human body is dynamic and unpredictable. To gain a deeper understanding of the physical phenomena on the human body, researchers need a more complete theoretical knowledge of how the entire body moves through harmonic coordination among different body parts that is commanded using sophisticated nerve systems. The techniques described herein can be used to advance such knowledge of the human body by, among other things, providing a highly flexible and truly distributed strain sensing optical fiber that can be used to create a wearable sensor network capable of sensing fundamental physical parameters, such as mechanical in-plane strain, on the surface of the human body, and collecting enough sensor data to create a self-learning, strain-based digital twin model for informing physical behavior and shape changes.

In particular, systems, methods, and apparatus described herein provide an optical fiber with high mechanical flexibility, or stretchability, and truly distributed strain sensing capability along the fiber direction, such that the fiber can be used to sense in-plane mechanical strains on a human body surface, or other biological structure or non-planar surface. In embodiments, the optical fiber comprises a self-sensing material, such as mechano-luminescent (“ML”) composites, that emits light upon sensing strain, thus enabling the fiber to operate without an independent light source. For example, the optical fiber may be comprised of a suitable elastomeric material, such as a polydimethylsiloxane (“PDMS”) fiber medium, and an array of microdots made of a suitable ML composite, such as zinc sulfide (ZnS) phosphors, integrated into a center of the fiber. In one exemplary embodiment, the composition of the ZnS particles can be varied by blending together various products of ZnS that are configured to emit different colors of light due to different doping materials (e.g., copper, manganese, etc.) and/or doping concentrations. This can create a unique, color-based “fingerprint” for the light emitted by each microdot (or “sensor node”) in the ZnS-PDMS array, for example. In another exemplary embodiment, the fiber can be configured to emit a unique light fingerprint for each sensor node by blending a ZnS phosphor configured to emit blue light with select combinations of red, green, and/or blue quantum dots. In various embodiments, the fiber medium can be encased with an optical encapsulant that has an optical refractive index configured to reflect back the light emissions from the ZnS microdots. Moreover, each end of the optical fiber can be coupled to an optical detector configured to obtain or capture the multi-colored light spectrum emitted by the self-sensing microdots. The detectors can be coupled to a data processor configured to generate a one-dimensional strain-mapping along the optical fiber based on the light emission spectrum captured within the optical fiber.

More specifically, because the one-dimensional, or linear, array is made up of a plurality of sensor nodes, each configured to emit a unique color spectrum when strained due to a combination of different-colored ML composites and/or quantum dots, the overall array can produce a unique light irradiance spectrum for each instance of in-plane strain mapping along the fiber. This is because in each instance, each sensor node may emit a different light emission spectrum depending on the particular strain that is placed at the corresponding location of the microdot. The optical detectors can be configured to collect all combinations of light irradiance spectrums emitted by the strain-activated dots in various instances over time. The data processor can be configured to store, in a database, the acquired light emissions data in association with a characterization of the corresponding mechanical strain. Based on the accumulated data, the data processor can determine how much mechanical strain occurred at each dot or node during a given instance. In some cases, the data processor can use advanced data processing powered by a neural network to calculate the amount of strain to map one-dimensional in-plane strain along the fiber. For example, the neural network may be trained with the database entries, using the mechanical strains as inputs and the corresponding light irradiance spectrums as outputs. The data processor can then use the trained neural network to determine the amount of strain present at each one-dimensional coordinate of the fiber based on the unique light “fingerprint” emitted by the corresponding node.

Various applications for the strain-sensing optical fiber are contemplated, including clothes-type health monitoring wearables that can directly track human body motion and shape changes for short term and long term monitoring, which can be used for assessing fitness effectiveness, early diagnosis of mental and physiological disease, and/or otherwise advancing knowledge about the human body. For example, a plurality of the optical fibers may be used to create a quasi-continuous strain sensor network that can be worn by a human subject and provide truly distributed sensing capability over a large strain-sensing range. The sensor network can be configured to use the captured light emission spectrum to map in-plane, two-dimensional strains on the corresponding body surface. As an example, professional and daily athletes, gamers, and space explorers, to name a few, may use the wearable strain sensor network to obtain accurate and comprehensive data regarding physical phenomena on their bodies. The strain sensor data gathered by the sensor network can also be used to build a strain-based digital twin model of the body surface and global movement that can self-learn to self-evolve using a neural network and be used for diagnosis and prognosis of health disorders, for example.

FIG. 1 illustrates an exemplary strain-sensing system 100 comprising an optical fiber 102, at least one optical detector 104, and at least one processor 106, in accordance with embodiments. The optical fiber 102 may be a highly flexible, truly distributed, strain-sensing optical fiber (“FD-SSOF”) that is configured to self-sense strain at any point along the fiber 102, as further described herein. In the illustrated embodiment, the optical fiber 102 comprises a first end 108 coupled to a first optical detector 104 and an opposing second end 110 coupled to a second optical detector 104, with a length extending between the two ends 108 and 110. In other embodiments, the system 100 may include a single detector 104 coupled to one end of the fiber 102. The at least one optical detector 104 can detect light emissions or other optical energy that is within, or transported by, the optical fiber 102, and can convert the detected light emissions into electrical energy or other output signal. In various embodiments, the at least one optical detector 104 may comprise a photodiode, a photomultiplier, a photovoltaic cell, or other suitable semiconductor device. In one exemplary embodiment, each of the first and second optical detectors 104 is a photomultiplier tube (“PMT”). In some embodiments, a length of the optical fiber 102 may be selected based on a range of the optical detectors 104, or their ability to adequately capture the light signals transported, or generated, within the fiber 102.

Each of the first and second optical detectors 104 may be communicatively coupled to the at least one processor 106 using a wired or wireless connection. The optical detectors 104 can be configured to transmit, to the at least one processor 106, strain sensor data or other output signal generated based on the light emission spectrum captured within the optical fiber 102. Based on the strain sensor data, the at least one processor 106 can be configured to generate a one-dimensional strain-mapping along the optical fiber 102. The at least one processor 106 can be any appropriate data processor suitable for executing software stored in a memory (not shown) of the system 100. While FIG. 1 shows a single processor 106, it should be appreciated that multiple processors (not shown) may be included in the system 100. For example, in other embodiments, each of the detectors 104 may be coupled to a separate processor 106 in order to more efficiently handle large amounts of strain sensor data. In such cases, the multiple processors may be coupled to a central system processor or aggregator (not shown) configured to combine and process all of the strain sensor data obtained by the detectors 104.

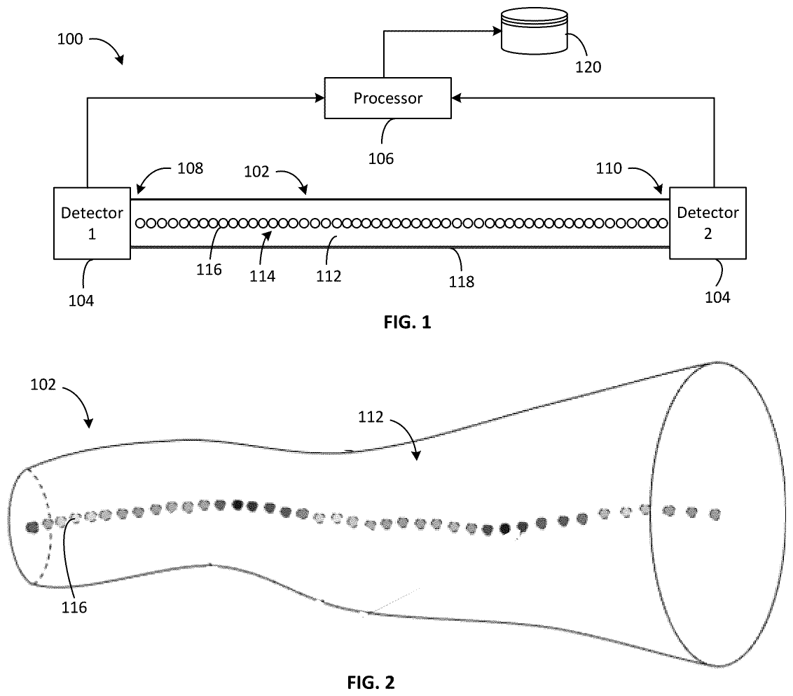

Referring additionally to FIG. 2, the optical fiber 102 comprises a core or fiber medium 112 and a self-sensing array 114 embedded or integrated into the fiber medium 112. The fiber medium 112 may be configured to have a substantially circular cross-section and may be comprised of a highly flexible or stretchable material capable of conforming to large strains, for example, as is often the case on the surface of the human body. For example, the fiber medium 112 may be configured to be freely deformable in a longitudinal direction of the fiber 102, or stretched lengthwise. In various embodiments, the fiber medium 112 may be made of a polydimethylsiloxane (“PDMS”) material, such as, e.g., Sylgard 184 kit from Dow Corning. In other embodiments, the fiber medium 112 may be made of any other suitable fiber optic material or elastomeric medium that has high mechanical flexibility and is compatible with the mechano-luminescent sensing material used in the self-sensing array 114 (e.g., ZnS phosphors or others, as described herein).

The self-sensing array 114 can be configured to extend along the length of the fiber medium 112 and through a center of the fiber medium 112, as shown. In embodiments, the self-sensing array 114 comprises a plurality of sensor nodes 116 configured to sense or detect mechanical strains at any point on the optical fiber 102 and thus, provide truly distributed, in-plane strain sensing capability along the entire length of the optical fiber 102. In particular, the sensor nodes 116 can be made of a self-sensing material that is configured to emit light in the visible or near visible spectrum in response to external mechanical stimuli, such as a mechanical strain or force on a human body surface, thus eliminating the need for an independent light source. Each sensor node 116 may be configured to sense mechanical strain in a direction that is tangential to the point at which the node 116 is located. The sensor nodes 116 may be inscribed or disposed at a centroid of the circular cross-section of the fiber medium 112 using any suitable fabrication technique, including, for example, a multi-material and co-axial direct ink writing (“DIW”) printer (e.g., BIO X6® by Cellink) or other additive manufacturing approach.

In various embodiments, the sensor nodes 116 may be sub-millimeter sized dots (or “micro dots”) of a mechano-luminescent (“ML”) sensing material. For example, the micro dots may be made of copper-doped zinc sulfide (“ZnS:Cu”) polydimethylsiloxane (i.e. ZnS:Cu-PDMS) micro-composites; a combination of copper and manganese doped zinc sulfide (“ZnS:Cu,Mn”) PDMS micro-composites; manganese-doped zinc sulfide (“ZnS:Mn”) PDMS micro-composites; or any other suitable ML-materials-based elastomeric composite that has a millimeter size or less.

As shown in FIG. 1, the plurality of sensor nodes 116 may be disposed in close proximity to each other so as to form a quasi-continuous one-dimensional, or linear, array (i.e. array 114) along the length of the fiber medium 112. The exact size, number, interval (e.g., distance between adjacent dots), and density (e.g., number of dots per unit length) of the sensor nodes 116 in the array 114 may vary depending on a target resolution for the strain sensor data obtained from the array 114, e.g., using the optical detectors 104. As will be appreciated, a higher density of nodes 116 may result in a more accurate strain measurement.

The sensor nodes 116 can be configured to exhibit unique light emissions characteristics at different strain levels, which can be used to identify the origin of each light signal captured by the optical detectors 104. In embodiments, each sensor node 116 may be configured to have a unique “fingerprint” by appropriately tuning the irradiance spectrum or peak wavelength of the light signal emitted by the node 116 in response to sensing a mechanical force or strain. In some cases, each sensor node 116 within the optical fiber 102 may be configured to emit light having a different irradiance spectrum, peak wavelength, or color, so that the light emission from each node 116 is uniquely identifiable. In other cases, at least some of the sensor nodes 116 may be configured to emit the same irradiance spectrum or light color but may be positioned at different locations of the array 114, for example, as part of a repeating pattern of colors, as shown in FIG. 2. In such cases, both the irradiance spectrum and a relative location of the captured light signal may be used to identify the origin of the light signal along the optical fiber 102. Other techniques may be used to associate detected light emission characteristics with the sensor node 116 from which the light signal originated, as will be appreciated.

The sensor nodes 116 can be individually tuned to a particular irradiance spectrum or wavelength by blending or combining different colored products at different mixing ratios. For example, the products may be different types of ZnS micro-particles, and each product type may be configured to emit a different color of light by using different copper and/or manganese doping concentrations to create the micro-particle (e.g., ZnS:Cu; ZnS:Cu, Mn; ZnS:Mn, etc.). In one exemplary embodiment, the different product types comprise ZnS micro-particles configured to emit blue light (e.g., LP-6864), green light (e.g., LP-6845), or orange light (e.g., LP-6814). Each of the sensor nodes 116 may be an individual ZnS composite formed by blending together different amounts of the different product types depending on the irradiance spectrum, wavelength, or light color desired for that composite. In some cases, the blending or doping ratios used to create each ZnS composite may be tuned or adjusted so that the light emitted from the corresponding sensor node 116 has a unique irradiance spectrum, wavelength, or light color, that can be used to identify the originating node 116 (i.e. an identifying fingerprint). For example, ZnS phosphors doped with select concentrations of copper and manganese (“ZnS:Cu, Mn particles”) may be used to provide a microdot configured to emit orange light, while appropriately doped ZnS:Cu phosphors may be used provide a microdot that emits blue or green light. In such cases, the color emitted by each microdot may be controlled by mixing the two phosphors and configuring their relative weight ratio (e.g., orange:green ratio) to tune the emitted light to a desired color or shade from orange to yellow to green to blue, for example.

In some embodiments, each sensor node 116 may be configured to emit a particular irradiance spectrum with unique peak wavelength(s) of light (or color) by mixing a single ML ZnS composite microdot configured to emit blue light with one or more quantum dots (“QDs”) configured to emit pure, or nearly pure, red, green, and/or blue colored lights. For example, the blue light emitted by the microdot may blend with the red, green, and/or blue colors emitted by the included quantum dots to create a new or different color (e.g., purple, violet, teal, etc.). The exact mixing ratio within each composite, or the quantity and color of each type of quantum dot, may vary depending on the light color, wavelength, or irradiance spectrum desired for the corresponding sensor dot 116. In embodiments, the ZnS microdots may be configured to emit a pure or deep blue light, as the deep blue color is known to help produce a more diverse range of colors when mixed with other colors (e.g., in the color space defined by the Commission Internationale de L′Eclairage (“CIE”)).

According to embodiments, the quantum dots may be sized at a nanometer or less and may comprise semiconductor particles configured to emit different colored lights. In particular, the quantum dots may be compound semiconductor quantum dots or perovskite quantum dots, and the core of each quantum dot may be doped with one or more metal ions to achieve a desired light color output. For example, some quantum dots may include a ZnS phosphor core doped with an appropriate concentration of copper ions, and/or other suitable metal, that is configured to cause each QD to emit a desired shade of blue light, such as, e.g., a pure blue. Other quantum dots may include a ZnS phosphor core doped with an appropriate concentration of copper and/or other metal ions that is configured to cause each QD to emit a pure green light. And still other quantum dot may include a ZnS phosphor core doped with an appropriate concentration of manganese and/or other metal ions that is configured to cause each QD to emit a pure red light.

The fiber medium 112 can serve as a transport medium for carrying the light emissions from the sensor nodes 116 to the optical detectors 104. As shown in FIG. 1, the optical fiber 102 further comprises a protective layer or coating 118 configured to contain the light emissions within the optical fiber 102. In particular, the protective layer 118 may be an optical encapsulant, or other cladding that encases or surrounds the fiber medium 112 and is configured to confine the light emissions within the fiber medium 112 by causing total internal reflection at the boundary between the protective layer 118 and the fiber medium 112. For example, the protective layer 118 may have a lower optical refractive index than the refractive index of the PDMS fiber medium 112, or may otherwise be configured to reflect back the light emissions from the ZnS microdots 116. In various embodiments, the protective layer 118 may be comprised of the optical encapsulant material OE-6550 from Dow Corning, or any other appropriate cladding material.

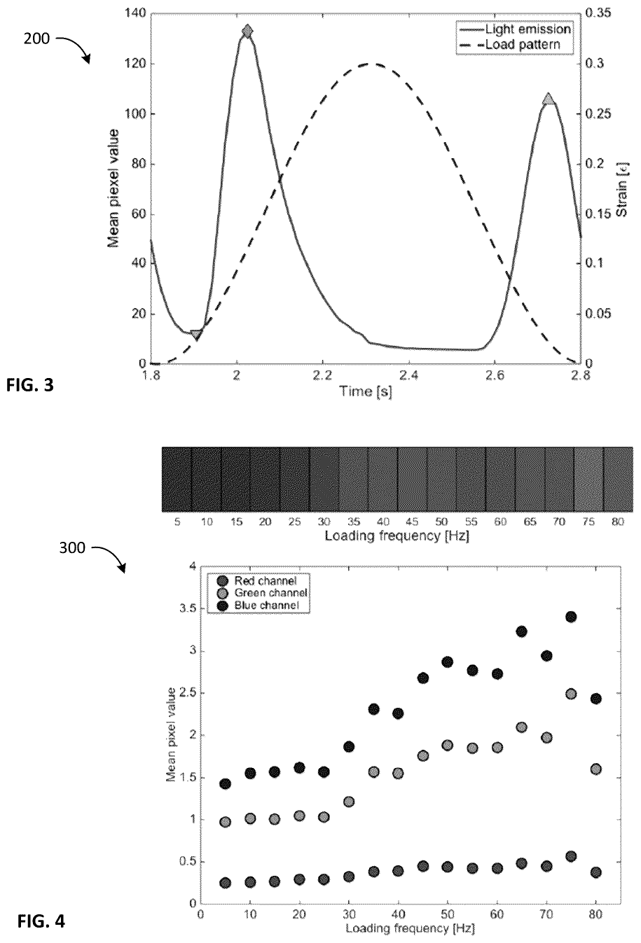

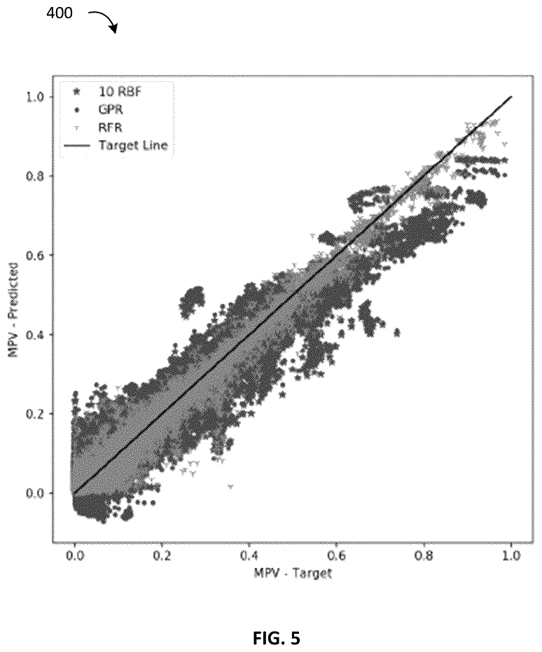

Referring now to FIGS. 3 through 5, shown are certain light emission characteristics of the ZnS:Cu-embedded PDMS micro-composites used in the optical fiber 102, in accordance with embodiments. In general, FIGS. 3 and 4 show that ML light color is affected by the strain rate applied to the ZnS:Cu PDMS composites, and that ML light intensity is affected by strain and strain rate. These experimental results are used for training a machine-learning algorithm to derive empirical constitutive equations on the relationship between ML light intensity and strain and strain rate. FIG. 5 shows that the trained machine-learning algorithm can predict ML light intensity with high accuracy (e.g., at least 90%). While the following description may refer to characteristics of ZnS:Cu PDMS microdots in particular, it should be appreciated that similar outcomes may be obtained using microdots composed of other ML-based elastomeric materials and/or doped with manganese and/or other suitable materials, additionally or alternatively, and/or including any suitable blend of red, blue, and green quantum dots plus a blue-light-emitting ZnS microdot, as described herein.

More specifically, FIG. 3 is a graph 200 illustrating how light intensity emitted by mechano-luminescent (“ML”) material varies depending on strain and strain rate. In particular, the ML light intensity exhibits a double peak over a cycle of tensile loading and unloading, which indicates that the ML light emission mechanism may be attributed to the mechanical deformation of the ZnS:Cu micro-particles, as well as another factor. For example, another cause or source of the ML light emissions can be frictions at the interfaces between the ZnS:Cu micro-particles, which may trigger electrons to overcome an energy barrier and move from valence band to conduction band, as will be appreciated.

FIG. 4 is a graph 300 illustrating how light color of mechano-luminescent (“ML”) material varies with strain rate and with varying loading frequency, while the maximum strain of the loading is kept constant, in accordance with embodiments.

FIG. 5 is a graph 400 illustrating ML light intensity predictions calculated using a trained three-layer feed-forward neural network and experimental data obtained after image processing high-speed video footage recording ML light emissions, in accordance with embodiments. More specifically, the graph 400 includes target plots comparing predictions from 10 radial basis function (“RBF”) summation, Gaussian process regressor (“GPR”), and random forest regressor (“RFR”) using total data sets for sinusoidal wave loading. As shown, this technique exhibits over 90 percent accuracy in prediction of ML light intensity with strain, strain rate, and strain history as inputs.

According to various embodiments, each optical detector 104 can be configured to capture a spectrum of colored lights in response to the optical fiber 102 being subject to external mechanical stimuli (such as in-plane strain on a human body surface) and provide an output signal that represents the captured light spectrum to the at least one processor 106. For example, the ML light signal generated by each ZnS:Cu-PDMS composite (e.g., sensor node 116), when subjected to cyclic tensile loadings, may be converted from radiant to electrical energy by the optical detector(s) 104. The optical detector(s) 104 can be further configured to generate, based on the energy conversion, a direct current (“DC”) voltage output that varies with magnitude of strain and strain rate. For example, a higher magnitude of DC current may indicate increased strain on the corresponding sensor node 116. Thus, the DC output signal may include a DC voltage measurement for each sensor node 116 that represents a magnitude or intensity of the ML light signal generated by that node 116.

The at least one optical detector 104 may provide the DC output as strain sensor data (also referred to herein as “strain information”) to the at least one processor 106 for mapping in-plane strain and strain rate on the human body and building a digital twin model that can self-learn and self-evolve based on ever-changing sensor data, as described herein. In some embodiments, the strain sensor data received at the processor 106 may also include, i.e. in addition to light intensity, wavelength information, information about extension and compression at the body surface, strain measurement information, strain rate information, strain direction information, and/or any other information determined based on the ML light signal. In some embodiments, each sensor node 116 may be associated with location information (e.g., coordinates) to indicate a position of the node 116 within the optical fiber 102. In such cases, the location information may be previously known, or stored, and may be provided to the processor 106 as part of, or in association with, the corresponding strain sensor data, to aid in the mapping and model-building processes described herein. In some embodiments, the strain sensing system 100 further comprises a database 120 for storing the strain sensor data in association with corresponding location information and/or other node identification information (e.g., a unique node identifier, etc.). The database 120 may be stored in a memory (not shown) of the system 100 and may be in communication with the at least one processor 106 via said memory. In some cases, the database 120 and the at least one processor 106 may be included in the same computing device. In other cases, the database 120 may be included in a separate standalone device that is in communication with the processor 106, via wired or wireless connection.

In some embodiments, the database 120 may be configured as an empirical database for storing ML light spectra from various mixtures of the three different types of ZnS (e.g., blue, green, and orange) at various locations in the PDMS fiber medium 112. The database 120 may be used to train a neural network, such as, e.g., a convolutional neural network (“CNN”), which can be used to acquire or generate a one-dimensional spatiotemporal in-plane strain map along the optical fiber 102. The strain map may visually represent changes along a surface or plane of the optical fiber 102 in response to various mechanical forces. In some cases, the strain map may be displayed on a display screen that is included in the system 100 and/or in communication with the at least one processor 106. The database 120 may also include ML light spectra information gathered in response to varying other factors, such as different sizes and shapes of the ML dot, different blending ratios of the three ZnS product types, etc. Moreover, the loading cases used to obtain the test data may be performed at various parts of the human body having different degrees of mechanical deformation, such as, for example, joints exhibiting concentrated and large deformation, a back showing medium and complex mode of deformation, and a chest showing a simple and medium deformation.

In some embodiments, though not shown in FIG. 1, the strain sensing system 100 may comprise a two-dimensional grid or network of optical fibers 102 configured to cover a larger area of the human body or other non-planar surface and/or capture higher resolution body surface deformation data due to the higher density of sensor nodes 116 provided by the fiber grid. For example, a plurality of optical fibers, each identical to the optical fiber 102 shown in FIG. 1, may be woven together in a grid-like fashion to form clothing or other wearables that can be worn by a human subject and used to measure strain and strain rate across a two-dimensional area of the human body. In such cases, the system 100 may include a plurality of optical detectors 104 coupled to respective ends of the plurality of optical fibers 102 for capturing visible or near visible light spectra emitted by the plurality of sensor nodes 116 embedded in each of the optical fibers 102 in response to experiencing mechanical strains. The at least one processor 106 may be configured to receive a plurality of output signals from the plurality of optical detectors 104 and derive, from the received light spectra sensor outputs, in-plane strain and strain rate data for each sensor node 116 included in the fiber grid (also referred to as a “sensor network”). The at least one processor 106 may also be configured to use a machine-learning algorithm to generate a two-dimensional map representing the spatiotemporal in-plane strains and strain rates detected across the body surface.

In some embodiments, the at least one processor 106 may be configured to use the two-dimensional map to build a physical digital twin model of the body surface that is capable of self-learning to self-evolve. For example, the physical digital twin model may be configured to self-learn by using a machine-learning algorithm that receives, as inputs, the two-dimensional strain sensor data obtained using the fiber grid. The model may use the strain values in that data to track the physical movement and changes on the subject body surface and may use the strain rate data to animate dynamic behavior of the body surface. The machine-learning algorithm may be configured to automatically update or correct the model, periodically, based on historical sensor data, actual body measurements and data, and other inputs (e.g., age, diet, current date, etc.) in order to improve an accuracy of the model and self-evolve.

Thus, a novel strain-sensing optical fiber is provided that exhibits high mechanical flexibility and truly distributed strain sensing capability along the fiber direction. In addition, the optical fiber provides large strain sensing range and the ability to obtain higher density strain sensor data without the use of an independent light source. These and other features make the optical fiber described herein optimal for sensing in-plane mechanical strain along a human body surface or other non-planar biological structure, for example, as a health-monitoring wearable. More specifically, the optical fiber may comprise a PDMS fiber medium, or other suitable elastomeric material, encased in an optical encapsulant (or cladding) configured to contain light emissions from an array of self-sensing nodes (or sensor nodes) inscribed at the center of the fiber medium. Each sensor node may comprise a microdot made of a ZnS-PDMS composite, or the like, that is configured to emit light having a unique irradiance spectrum, peak wavelength, or color in response to sensing strain along the fiber direction. In some cases, the irradiance spectrum (or “fingerprint”) for each sensor node is determined based on the blending ratio and copper (and/or manganese) doping concentrations of the ZnS products that are combined to create the microdot. In other cases, the irradiance spectrum for a given sensor node may be determined by blending a ZnS microdot, doped with copper or other metal to create a deep blue light emission, with a select mix of quantum dots, doped with certain metal ions (e.g., Cu, Mn, etc.) to create red, blue, or green colored light emissions. In either case, optical detectors, such as photomultipliers, are attached to the ends of the optical fiber to capture the light emission spectrum generated by the sensor nodes in response to sensing strain and provide corresponding strain sensor data to a data processor for acquiring a one-dimensional strain mapping along the optical fiber. In some cases, a plurality of the optical fibers may be weaved into a grid or network to cover a larger body surface. In such cases, the strain sensor data captured by the fiber network may be provided to a machine-learning algorithm and/or a neural network to acquire a two-dimensional strain mapping across the body surface and to build a physical digital twin model that can self-evolve for diagnosis and prognosis of health disorders.

Any processor described herein can be a data processor or any other appropriate hardware device for executing software instructions retrieved from a memory (not shown), such as, for example, a central processing unit (CPU), a graphics processing unit (GPU), a semiconductor-based microprocessor (in the form of a microchip or chip set), or another type of microprocessor.

Any memory described herein can be any appropriate memory device suitable for storing software instructions, such as, for example, a volatile memory element (e.g., random access memory (RAM, such as DRAM, SRAM, SDRAM, etc.)), a nonvolatile memory element (e.g., ROM, hard drive, tape, CDROM, etc.), or any combination thereof. Moreover, the memory may incorporate electronic, magnetic, optical, and/or other types of storage media. In some embodiments, the memory includes a non-transitory computer readable medium for implementing all or a portion of one or more methods described herein. The memory can store one or more executable computer programs or software modules comprising a set of instructions to be performed, such as, for example, one or more software applications that may be executed by the at least one processor 106 to carry out the principles disclosed herein. The executable programs can be implemented in software, firmware, hardware, or a combination thereof.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

What is claimed is:

1. An optical fiber, comprising:
a core configured to be deformable in a longitudinal direction of the fiber, the core comprising an elastomeric material;
a plurality of sensor nodes disposed at a center of the core and arranged in close proximity to form a linear array along a length of the core, each sensor node comprising a mechano-luminescent (“ML”) composite configured to emit a select color of light in response to detecting a mechanical force at a location of the sensor node; and
a coating configured to surround the core and confine light emissions to within the core.

2. The optical fiber of claim 1, wherein the elastomeric material comprises polydimethylsiloxane (“PDMS”).

3. The optical fiber of claim 1, wherein the ML composite comprises zinc sulfide (“ZnS”).

4. The optical fiber of claim 1, wherein the ML composite comprises copper-doped zinc sulfide (“ZnS:Cu”).

5. The optical fiber of claim 1, wherein the ML composite comprises zinc sulfide (“ZnS”) doped with copper and manganese (“ZnS:Cu, Mn”).

6. The optical fiber of claim 1, wherein the ML composite comprises a microdot of copper-doped zinc sulfide (“ZnS:Cu”) and one or more quantum dots, each quantum dot comprising a zinc sulfide (“ZnS”) core doped with one or more metal ions.

7. The optical fiber of claim 1, wherein the coating is configured to cause total internal reflection of light emissions from the sensor nodes by having a first refractive index that is lower than a second refractive index of the core.

8. The optical fiber of claim 1, wherein the core is configured to extend through the optical fiber longitudinally and have a substantially circular cross-section, and the linear array of sensor nodes is disposed at a centroid of the circular cross-section.

9. The optical fiber of claim 1, wherein the plurality of sensor nodes are configured to: emit a first color spectrum in response to sensing a first mechanical strain, and emit a second color spectrum, different from the first spectrum, in response to sensing a second mechanical strain different from the first strain.

10. A strain-sensing system, comprising:
an optical fiber configured to sense a mechanical force on the fiber and in response, emit a spectrum of colored lights, wherein the optical fiber comprises a linear array of sensor nodes disposed along a central core of the optical fiber, and each sensor node is configured to emit a select one of the colored lights upon sensing the mechanical force at a location of the sensor node;
at least one optical detector coupled to the optical fiber and configured to: detect the spectrum of colored lights emitted by the sensor nodes, and generate an output signal based on the detected spectrum, the output signal representing strain information for corresponding node locations along the optical fiber; and
at least one processor communicatively coupled to the at least one optical detector and a database, the at least one processor configured to:
receive the output signal from the at least one optical detector;
derive the strain information from the output signal;
store the strain information in the database in association with the corresponding node locations; and
generate, based on information obtained from the database, a strain map for the optical fiber.

11. The system of claim 10, wherein the central core comprises an elastomeric material that is deformable in a longitudinal direction of the fiber.

12. The system of claim 11, wherein the elastomeric material comprises polydimethylsiloxane (“PDMS”).

13. The system of claim 10, wherein each sensor node comprises a mechano-luminescent (“ML”) composite configured to emit the select colored light upon sensing the mechanical force.

14. The system of claim 13, wherein the ML composite comprises zinc sulfide (“ZnS”).

15. The system of claim 10, wherein the at least one optical detector comprises a photomultiplier tube.

16. The system of claim 10, wherein the at least one optical detector comprises a first optical detector coupled to a first end of the optical fiber, and a second optical detector coupled to a second end of the optical fiber.

17. The system of claim 10, wherein the at least one processor is further configured to: receive location information for each sensor node, and store the location information in the database in association with the strain information obtained for the corresponding sensor node.

18. The system of claim 10, wherein the spectrum of colored lights comprises visible and/or near visible wavelengths of light.
